(19) United States
(12) Patent Application Publication
(10) Pub. No.: US 2010/0131139 A1
(43) Pub. Date: May 27, 2010

(54) Charge planning apparatus

(75) Inventors: Tadashi Sakai, Obu-city (JP); Kazunao Yamada, Toyota-city (JP); Yusuke Mizuno, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/590,610

(22) Filed: Nov. 11, 2009

(30) Foreign Application Priority Data
Nov. 25, 2008 (JP) 2008-299172

(51) Int. Cl. B60W 20/00; G06F 1/28

(52) U.S. Cl. 701/22; 700/291; 903/903

(57) ABSTRACT

A charge planning apparatus that formulates a control plan for controlling both of a motor and a generator in a hybrid vehicle performs a control plan re-formulation by changing a control index that provides a basis for state of charge (SOC) estimation, when a modification of the control plan based on a current SOC during the travel of the hybrid vehicle results in an excessive charging or discharging portion in a transition of the modified SOC estimation.

### CROSS REFERENCE TO RELATED APPLICATION

The present application is based on and claims the benefit of priority of Japanese Patent Application No. 2008-299172, filed on Nov. 25, 2008, the disclosure of which is incorporated herein by reference.

### FIELD OF THE INVENTION

The present invention generally relates to a charge planning apparatus for planning a charge-discharge control of a battery that is used in a hybrid vehicle.

### BACKGROUND INFORMATION

A well-known technology of a “hybrid vehicle” uses both an internal combustion engine and a secondary battery for driving the vehicle. That is, the battery provides the electric power to drive a motor; in addition to the engine, for generating a rotational driving force of the vehicle. Further, the power from the engine is used to drive a generator for generating electricity, for charging the battery. Further, the battery is charged by the electricity generated by the braking of the vehicle (i.e., a so-called regenerated electric current/power). By employing the above-described power utilization scheme, the hybrid vehicle achieves a higher fuel mileage, in comparison to, for example, a gasoline engine vehicle.

Furthermore, for the purpose of further reducing the fuel consumption and maximizing the fuel mileage, the motor and the engine is controlled according to an operation plan. That is, by suitably coordinating and planning the operation of the motor and the engine according to the expected travel route towards the destination, the fuel consumption is minimized. Refer to, for example, Japanese patent documents No. JP-A-2000-333305 (i.e., U.S. Pat. No. 6,314,347), and No. JP-A-2001-183150.

In the case, because of unexpected traffic congestion and/or a specific travel condition of the driver on a certain date/time, the operation plan may not necessarily be fully observed, thereby resulting in deterioration of an expected fuel mileage increasing effect. As a measure for coping with the kind of problem, re-planning of the operation plan as required during the travel of the vehicle is currently known. Refer to, for example, Japanese patent document No. JP-A-2007-50888.

For example, if the current state of charge (abbreviated as “SOC”) actually detected during the travel of the vehicle and the planned SOC are discrepant by a certain threshold value or more, the original plan is discarded and a new plan is formulated, according to the disclosure of the above patent document. Therefore, according to the above document, the operation plan can be adaptively and promptly formulated and re-formulated according to day-by-day changes of the travel condition, thereby further contributing to the reduction of the fuel consumption.

However, the planned SOC and the current SOC are almost always discrepant on an actual condition of the road. Therefore, if the operation plan is re-formulated based on every discrepancy between the planned SOC and the current (i.e., actual) SOC, the re-planning of the operation plan is triggered very frequently, thereby causing a considerable amount of re-planning process load or overhead. Further, when the re-planning is performed based only on the relationship between the planned SOC and the actual SOC, the fuel mileage may not necessarily be improved.

### SUMMARY OF THE DISCLOSURE

In view of the above and other problems, the present disclosure discloses a technique that improves the fuel mileage of a hybrid vehicle by suitably re-planning an operation plan of a motor and an engine during a travel of the hybrid vehicle as well as avoiding excessive re-planning.

Further, a process load for re-planning is reduced in the present disclosure by avoiding complex re-planning calculation such as calculation of a charge/discharge amount based on the vehicle speed, the grade of slope and the like.

The charge planning apparatus is used in the hybrid vehicle that is driven by a power of an internal combustion engine and a power of a battery.

In an aspect of the present disclosure, the charge planning apparatus includes: a controller for controlling (a) driving of the hybrid vehicle by the battery and (b) charging of the battery based on a received control index; a plan formulator for formulating a plan of the control index on an expected travel route of the hybrid vehicle and for predicting a charge amount transition of the battery on the expected travel route based on the control index output to the controller; a modification determiner for determining modification of the plan during a travel of the vehicle on the expected travel route based on (a) the charge amount transition caused by the output of the control index according to the plan and (b) a current battery charge amount; a plan modifier for modifying the plan based on an affirmative determination of the modification determiner and for predicting the charge amount transition on the expected travel route according to the control index output to the controller corresponding to the modified plan; and an output generator for outputting the control index to the controller according to the plan.

Further, the apparatus performs the following control. That is, (i) the modification determiner modifies, based on the current battery charge amount that is actually observed, the charge amount transition according to the control index output to the controller corresponding to the plan, and (ii) the modification determiner determines to change the plan when the modified charge amount transition has an excessively charging or discharging portion of the battery charge amount.

In other words, the control index plan is modified (i.e., re-planning or change of the control index) under a trigger of the charge amount of the battery having an excessively charging/discharging portion in a modified/corrected plan of charge amount transition that is formulated by the actually observed current battery charge amount.

In this manner, the frequency of re-planning or plan change is decreased, and the fuel mileage is improved by the re-planning. Now, FIG. 10 is used to explain this advantageous feature of the present disclosure. That is, in FIG. 10, the horizontal axis of the graph is the travel distance along the navigation route, and the vertical axis is the charge amount, i.e., the SOC. The area in the graph above the MAX of the charge amount indicates the over-charging, and the area below the MIN of the charge amount indicates the over-discharge. When the charge amount is in an over-charge/discharge condition, the fuel mileage improvement effects are diminished.

In the conventional operation scheme, regardless of whatever the estimation of the SOC transition according to the original plan (along a solid line 71) is, the re-planning is performed whenever the actual SOC (along a dotted line 72) departs from the SOC estimation 71 by a departure amount 73 that exceeds a certain threshold. Therefore, even when the hybrid vehicle is traveling on a level road that does not require a large amount of charge and discharge, with a sufficient margin from the MAX/MIN of the charge amount in the above graph, the re-planning is uniformly performed upon detecting the departure amount 73 exceeding the threshold. That is, the re-planning is unnecessarily performed when it is not required. Repetition of the unnecessary re-planning that does not provide a prospect of the fuel mileage improvement is, in other words, the frequent useless re-planning.

On the other hand, the charge planning apparatus of the present disclosure performs the re-planning only when “there are excessive charging/discharging portions in the modified SOC transition that is modified based on the current (latest) SOC at the moment.” In other words, the re-planning is selectively performed only when the fuel mileage improvement effects are diminished. Therefore, the number of useless re-planning is reduced, thereby enabling the reduction of the process load for the re-planning.

Further, the charge planning apparatus is used in the hybrid vehicle that is driven by a power of an internal combustion engine and a power of a battery for an improvement of the fuel mileage in the following manner.

That is, the charge planning apparatus includes: a controller for controlling (a) driving of the hybrid vehicle by the battery and (b) charging of the battery based on a received control index; a plan formulator for formulating a plan of the control index on an expected travel route of the hybrid vehicle and for predicting a charge amount transition of the battery on the expected travel route based on the control index output to the controller; a modification determiner for determining modification of the plan during a travel of the vehicle on the expected travel route based on (a) the charge amount transition caused by the output of the control index according to the plan and (b) a current battery charge amount; a plan modifier for modifying the plan based on an affirmative determination of the modification determiner and for predicting the charge amount transition on the expected travel route according to the control index output to the controller corresponding to the modified plan; an output generator for outputting the control index to the controller according to the plan; and a recorder for recording, in a memory medium prior to formulation of the plan for the expected travel route by the plan formulator, variation of the battery charge amount according to the control index output to the controller, when the expected route is divided into multiple sections and the variation of the battery charge amount is predicted for multiple component values of the control index for respective sections of the expected travel route.

Further, in the charge planning apparatus, the plan modifier formulates a control index use plan that defines use of the multiple components of the control index in each of the multiple sections of the expected travel route in the modified plan, by utilizing the recorded variation of the battery charge amount for respective sections of the expected travel route and respective components of the control index.

In the above described manner, if the transition of SOC estimation in a certain route is recorded for section by section and index by index, the records of those data can be utilized for more efficient re-planning of the SOC estimation, especially for the modification of the SOC plan during the travel, thereby enabling a substantial reduction of the process load of re-calculation of charge/discharge amount of electricity based on the vehicle speed, slope angle and the like.

### BRIEF DESCRIPTION OF THE DRAWINGS

Objects, features, and advantages of the present disclosure will become more apparent from the following detailed description made with reference to the accompanying drawings, in which:

FIG. 1 is a schematic diagram of a hybrid vehicle in an embodiment of the present disclosure;

FIG. 2 is a block diagram of a navigation ECU and connected components in the embodiment;

FIG. 3 is a flowchart of a learn control process in the embodiment;

FIG. 4 is an illustrative diagram of a generated electricity power and an assist electricity power in each of the sections for different control indexes in the embodiment;

FIG. 5 is a flowchart of a SOC planning process in the embodiment;

FIG. 6 is an illustrative diagram of a simple SOC change map in the embodiment;

FIG. 7 is an illustrative diagram of a sample SOC plan in the embodiment;

FIG. 8 is a flowchart of details of the SOC planning process in the embodiment;

FIG. 9 is a flowchart of a travel time process in the embodiment;

FIG. 10 is an illustrative diagram of transition of a battery charge amount at a time of re-planning in a related art;

FIG. 11 is an illustrative diagram of SOC transition showing an operation example of the travel time process in the embodiment;

FIGS. 12A and 12B are diagrams of SOC loss and gain in each section for the control indexes of 50 and 40 associated with a planned SOC in the embodiment;

FIG. 13 is a flowchart of the details of the learn control process in the embodiment; and

FIG. 14 is an illustrative diagram of generation cost and assist cost relative to a threshold cost after re-planning in the embodiment.

### DETAILED DESCRIPTION

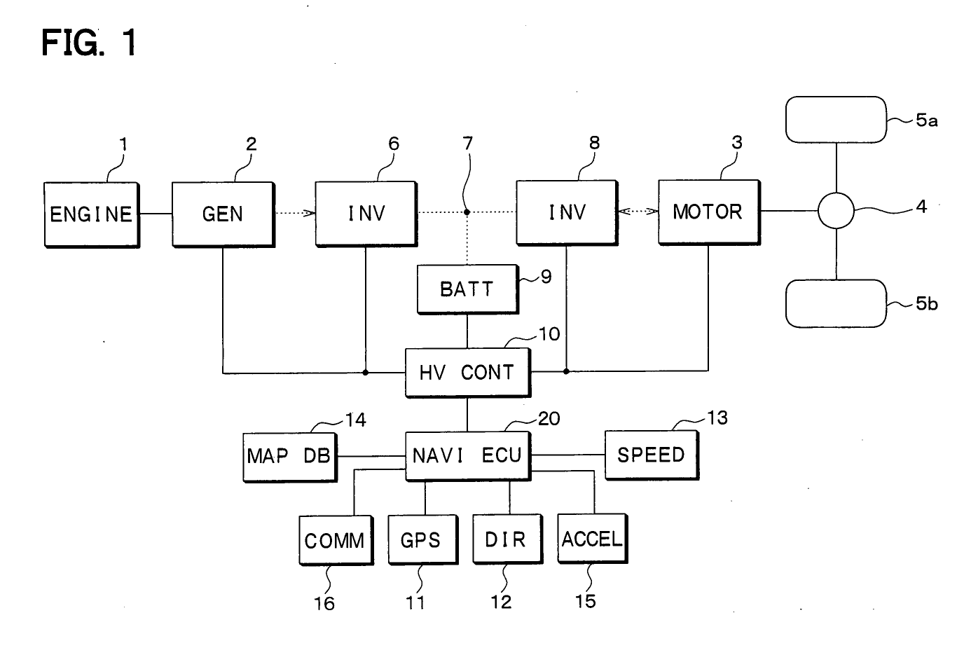

Hereinafter, the present invention is described as an embodiment and its modifications. FIG. 1 shows a schematic diagram of a hybrid vehicle in an embodiment of the present disclosure. The hybrid vehicle includes an internal combustion the engine 1, a generator motor 2, a power motor 3, a differential device 4, a tire 5a, a tire 5b, an the inverter 6, a DC link 7, an inverter 8, a secondary battery 9, an HV controller 10, a GPS sensor 11, a direction sensor 12, a speed sensor 13, a map DB storage 14, an acceleration sensor 15, a wireless communication device 16, and a navigation ECU 20.

The hybrid vehicle travels by using the engine 1 and the motor 3 as its power source. When the engine 1 is used as a power source, the rotation force of the engine 1 is transmitted to the tires 5a and 5b through the clutch mechanism (not shown in the drawing) and the differential device 4. When the motor 3 is used as a power source, the direct current electric power of the battery 9 is converted into the alternating current electric power by the DC link 7 and the inverter 8, and the motor 3 is driven by the alternating current electric power to transmit the rotation force of the motor 3 to the tires 5a and 5b through the differential' device 4. Hereinafter, the travel mode of the hybrid vehicle is designated either as two modes of an engine-powered travel or a motor-assisted travel depending on the power source. That is, when the vehicle is traveling on the power of the engine 1, the vehicle is in the engine-powered travel mode, and when the vehicle is traveling on the power of at least the motor 3 from among the two power sources of the engine 1 and the motor 3, the vehicle is in the motor-assisted travel mode. Further, when the vehicle is traveling solely on the power of the motor 3, the travel of the vehicle is specifically designated as an EV travel mode. Please note, in the following description, that the term “power” may be used for representing both of (a) the physical horse power generated by the engine/motor and (b) the electric power of the electric current exchanged between the battery, the generator and the motor.

Further, the rotation force of the engine 1 is also transmitted to the generator motor 2 to generate the alternating current electric power, and the generated alternating current electric power is converted into the direct current electric power by the inverter 6 and the DC link 7. The direct current electric power may be stored and accumulated in the battery 9. In this case, the charging of the battery 9 is the charging by the operation of the engine 1 which uses fuel. Hereinafter, the charging of the electric power by the generator motor 2 which is driven by the rotation force of the engine 1 is designated as an internal-combustion charging.

Further, at the time of braking of the hybrid vehicle, the rotation force from the tires 5a, 5b is utilized to drive the motor 3, thereby generating the alternating current electric power that is to be converted into the direct current electric power by the inverter 8 and the DC link 7, and is to be stored and accumulated in the battery 9. Hereinafter, the charging by using the motor 3 at the time of braking is designated as re-generation.

Therefore, the hybrid vehicle can be driven by both of the engine power and the battery power, when the engine 1, the battery 9, the motor 3 and the generator motor 2 are installed in the vehicle in the above-described manner. That is, the hybrid vehicle is driven by the engine 1, and by the motor 3 with the battery 9 as its power source, and by the generator motor 2 that generates the charging electric power for the battery 9.

The HV controller 10 controls, according to the instructions from the navigation ECU 20 as well as other instructions, execution and non-execution of an operation of hybrid control actuators such as the generator motor 2, the power motor 3, the inverter 6, the inverter 8 and the like as described above.

More practically, the control by the HV controller 10 is, for example, regarding the control of performing either of the engine-powered travel or the motor-assisted travel, regarding the control of whether or not to perform the internal-combustion charging, regarding the control of whether or not to perform the re-generation, regarding the control of how output from the engine 1 and output from the motor 3 are combined in the motor-assisted travel, regarding the control of how the rotation force of the engine 1 is transmitted and distributed among the tires 5a, 5b and the generator motor 2. The HV controller 10 may, for example, be realized by a microcomputer, or other hardware of dedicated circuitry as described in the following description.

That is, more specifically, the HV controller 10 stores a “current SOC” value, and performs the following processes A and B.

Process A

The process A receives control index data from the navigation ECU 20 repeatedly, and controls the generator motor 2, the power motor 3, the inverter 6, the inverter 8 together with other components to satisfy the request of driving force from the driver of the vehicle and to decrease the fuel consumption, based on the latest control index value received from the ECU 20.

Process B

The process B notifies the navigation ECU 20 of the current SOC at regular intervals.

In this case, the SOC stands for “State of Charge,” an index of charge condition of the battery 9. When the SOC value takes a greater value, the charge amount of the battery is greater. The current SOC is the SOC value observed at the moment. The value of the current SOC is regularly updated by the HV controller 10 based on the detected condition of the battery 9.

Further, the control index is an index for standardizing and controlling the output of the engine 1, the generator motor 2, and the power motor 3, under control of the HV controller 10. That is, the control index defines a standard value for determining how the hybrid control actuator is controlled. More specifically, it is a value for determining which of the motor-assisted travel or the internal-combustion charging is performed. For example, in case a “power threshold” (described later in detail) is employed as the control index, the frequency of the motor-assisted travel by using the motor 3 is increased relative to the frequency of the charging of the battery 9 by the generator motor 2 when the control index value decreases. (In the following, the motor-assisted travel may simply be designated as the “discharge,” and the charging of the battery 9 may simply be designated as the “power generation.”) In other words, a ratio of the motor power output (of the motor 3) over the engine power output (of the engine 1) increases, and a ratio of the generated power (of the generator motor 2) over the engine power output (of the engine 1) decreases, when the control index value decreases. When the control index is selected by the navigation ECU 20, the power generation amount and the power assist amount (described later in detail) under control of the HV controller 10 can be changed, and adjusted.

The GPS sensor 11, the direction sensor 12 and the speed sensor 13 are well-known sensors for detecting the position, the travel direction and the travel speed of the hybrid vehicle. The acceleration sensor 15 is a well-known sensor for detecting the acceleration of the vehicle. By utilizing the acceleration sensor 15 and the speed sensor 13 in a well-known manner, the inclination (i.e., a slope angle) of the hybrid vehicle in a front-rear direction can be calculated. The wireless communication device 16 is a well-known device for performing the radio communication with an outside device existing on an outside of the vehicle.

The map DB storage 14 is a storage medium for storing map data. The map data includes node data to represent each of the multiple intersections and link data to represent each of the multiple links. An entry of the node data has an ID number, position information, and type information of the relevant node. An entry of the link data has an ID number (i.e., a link ID), position information, road type information (such as an expressway, a national road, a prefectural road, a street or the like), average slope information and the like of the relevant link.

The position information of the link data includes (a) position data of shape interpolation points in the relevant link, and (b) segment data of segments that connect two adjacent points including the shape interpolation points and two end nodes of the link. The segment data includes a segment ID, a slope of the segment, a direction of the segment, a length of the segment and the like.

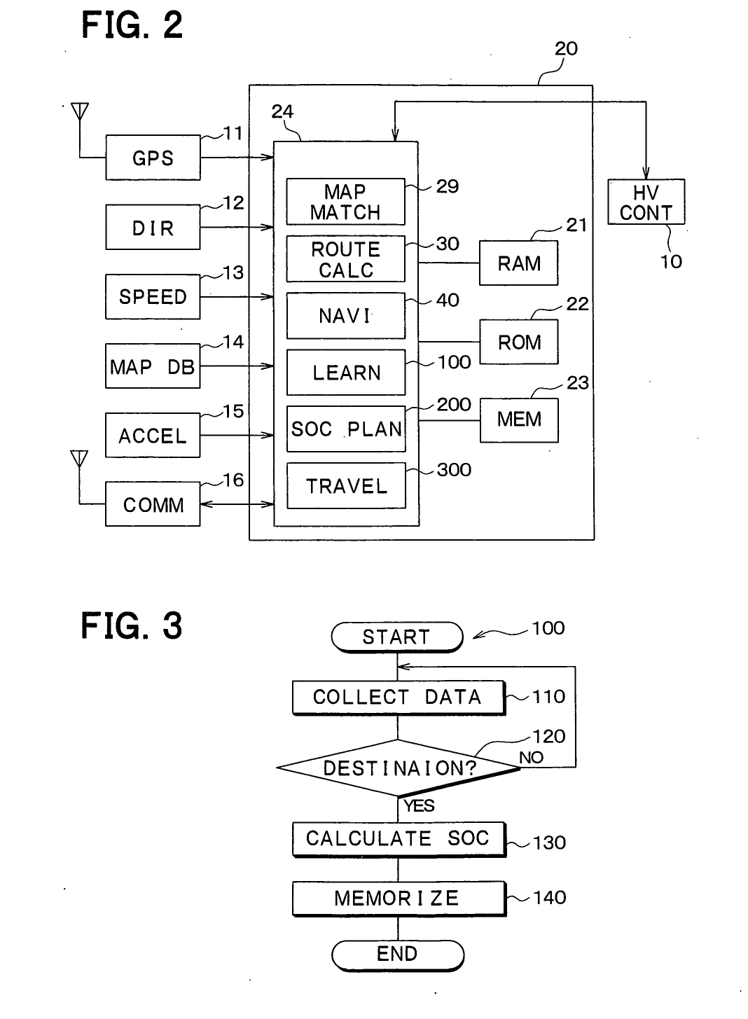

As shown in FIG. 2, the navigation ECU 20 has a RAM 21, a ROM 22, a durable storage media 23 on which data is writable, and a control unit 24. The durable storage media is storage media which can retain data even when the supply of the main electrical power for the navigation ECU 20 stops. For example, a nonvolatile memory medium such as a hard disk, a flash memory, an EEPROM or the like as well as a back-up RAM may serve as the durable storage media 23.

The control unit 24 executes a program retrieved from either of the ROM 22 or the durable storage media 23, together with information retrieved from the RAM 21, the ROM 22, and the durable storage media 23 in the course of execution of the program. Further, the control unit 24 writes information on the RAM and the durable storage media 23, and exchange signals with the HV controller 10, the GPS sensor 11, the direction sensor 12, the speed sensor 13, the map DB storage 14, the acceleration sensor 15 and the like.

More specifically, the control unit 24 realizes a map matching process 29, a route calculation process 30, a navigation process 40, a learn control process 100, a SOC planning process 200, and a travel time process 300 by the execution of the program.

In the map matching process 29, the control unit 24 determines which road in the map of the map DB storage 14 the current vehicle position corresponds to, based on information from the GPS sensor 11, the direction sensor 12, the speed sensor 13, the acceleration sensor 15 and the like.

In the route calculation process 30, the control unit 24 determines an optimum route to the destination using the map data. In addition, the destination may be input based on an instruction of the destination by the driver through an operation device not illustrated in the drawing. Alternatively, the destination may be automatically calculated instead of receiving the instruction from the driver.

When the destination is automatically calculated, it may be recalled from the destination history. That is, by storing the destination history as information of the destinations of past travels with the day of the week and time of the travel on the durable storage media 23, the most matching entry of the destination history is retrieved from the media 23 based on the current day of the week and time. The driver of the vehicle may then be informed of the calculated destination and the route to the destination vocally or visually, for the confirmation that the calculated destination is the desired one. The driver may confirm the destination by providing a confirmation input from an input device.

In the navigation process 40, the control unit 24 displays a guide screen for guiding the driver of the hybrid vehicle along the optimum route to the destination that is calculated by the route calculation process 30, by using a display and a speaker, for example.

The learn control process 100 is now explained in detail. In the learn control process 100, the control unit 24 records, throughout the travel of the vehicle, various information to the durable storage media 23 as the information which is later utilized by the SOC planning process 200. The flowchart of the learn control process 100 is shown in FIG. 3.

The control unit 24 starts the learn control process 100 when the navigation process 40 starts the route guidance towards the destination, and collects travel data in steps 110, 120 until the vehicle arrives at the destination.

For example, the travel data is repeatedly collected at a certain time interval (e.g., 0.1 second interval), or at a certain timing (e.g., for travel of one meter by the hybrid vehicle). The point where the travel data is collected is designated as travel data collection point hereinafter. The collected travel data includes a vehicle position (e.g., longitude and latitude) of the hybrid vehicle at the data collection timing, a travel speed V, an inclination θ in the travel direction (e.g., topographical/geographical information), acceleration in the travel direction among other information. The travel data is detected based on the signals from the GPS sensor 11, the direction sensor 12, the speed sensor 13, and the acceleration sensor 15.

In addition, the collected travel data is recorded to the RAM 21 or the durable storage media 23 in a categorized manner for every section of the traveled road.

The length of the section may be extremely longer than, for example, a distance that is traveled by the vehicle traveling at 50 km/h for the time duration of 100 times of the data collection interval.

Further, as for the section length, every section has the same length, or the section may be divided at a point where certain information is changed (e.g., the speed change, the inclination change, the change of the degree of congestion, or the like), or where data in the information exceeds a certain threshold. Furthermore, a link in the map data may be regarded as a section, or a segment in the map data may be regarded as a section.

Further, two or more section division methods may be combined. That is, every section may have the same distanced within a certain range from the start point and the destination of the navigation route, and the other sections in the navigation route may have one link or one segment in each section. In the present embodiment, when the traffic is bi-directional, the same sections having different (i.e., opposite) traffic direction are considered as respectively different sections.

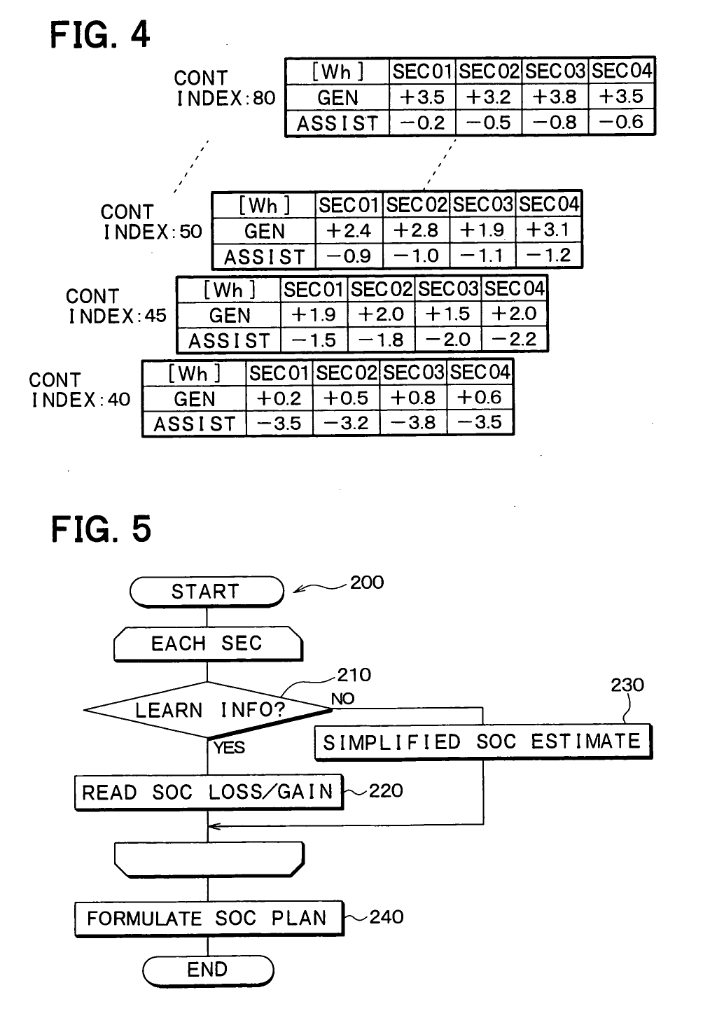

In step 130, when arriving at the destination, the control unit 24 calculates SOC loss and gain in every section of the navigation route based on the collected travel data according to each of the control indexes. An example of the SOC loss and gain calculated for each of the control indexes is shown in FIG. 4.

The SOC loss and gain in each of the sections in the route are not the actual SOC transition observed in the course of travel along the navigation route, but the amount of SOC change in a section if a certain control index value is assumed for that section. For the calculation of the SOC loss and gain, multiple control index values are prepared. That is, the control index values may have the same value interval throughout the possible index value range to define 10 pieces or 100 pieces of index values, for example.

The total SOC loss and gain in a certain section are calculated based on the collected travel data at every data collection point for each of the control index values. That is, the sum of the SOC losses and gains at each of the data collection points in a section for a certain control index is calculated as the SOC loss and gain of that section. However, the SOC loss and gain are recognized as the generated electric power and the electric power used for assistance, and a total amount of the generated electricity power (i.e., power generation amount) and a total amount of the assist electricity power (i.e., power assist amount) are calculated separately.

The power generation amount means that the amount of electric power accumulated in the battery 9 when the internal-combustion charging or re-generation is performed by employing a control index at a travel data collection point. Further, the power assist amount mean the amount of electric power consumed from the battery 9 when the motor-assisted travel is performed by employing a control index at a travel data collection point.

The SOC loss and gain calculation is performed by the following two calculation steps at a travel data collection point by employing a certain control index value.

(Calc-Step 1)

Based on the travel data collected at a travel data collection point, a travel load P is calculated for that data collection point.

(Calc-Step 2)

Based on the calculated travel load P and the employed control index, the power generation amount or the power assist amount for that data collection point is calculated. More practically, the power generation/assist amount between a data collection point and the next data collection point is calculated.

The travel load P is a product of a driving force R required to output by the hybrid vehicle and a travel speed V at that travel data collection point. The driving force R is calculated by using the following equation.

R=W·acc+μr·W+μ1·A·V·V+W·g·sin θ

In the above equation, ‘W’ is a total weight of the hybrid vehicle, ‘acc’ is acceleration of the hybrid vehicle, ‘μr’ is a rolling resistance coefficient, ‘μ1’ is an air resistance coefficient, ‘A’ is a front projection area size, ‘g’ is a gravitational acceleration, ‘θ’ is a road inclination (which takes the value of 0 when the road is level, and takes a positive value when the road is uphill, and takes a negative value when the road is downhill.) The values of W, μr, μ1, A, and g are stored in the ROM 22 in advance.

Alternatively, the control unit 24 may record the current travel load P to the media 23 at every data collection point during the travel, and the collected data of the travel load P may be retrieved from the media 23 later at the data collection point for performing the above Calc-Step 1 to calculate the travel load P.

The power generation amount or the power assist amount at the data collection point in the above Calc-Step 2 is, more practically, a power generation amount or a required power assist amount that is required to realize the physical driving force corresponding to the travel load P at that point based on the control of the HV controller 10 when the relevant control index value is output to the HV controller 10.

The power generation amount (i.e., the increase of the charge amount) or the power assist amount (i.e., the decrease of the charge amount) may also be calculated, based on the travel load P and the control index, by employing a hybrid system model that uses a set of input values of the travel load P and the control index and outputs the change of the charge amount. The hybrid system model may be stored as a map in the ROM 22 in advance.

In the above-described manner, the control unit 24 can calculate SOC loss and gain (i.e., the power generation/assist amounts) for each of the traveled sections in the navigation route, index by index for each of the control index values. Therefore, regardless of the actually-used control index in the current travel, the SOC loss and gain for the respective index values can be accurately calculated.

More practically, the total power generation amount in a certain section is calculated as a sum of the positive charge amount changes for the data collection points where the charge amount has a positive change value based on the above Calc-Step 2. That is, in other words, the total power generation amount is a total value of the increase of the charge amounts at the data collection points in the relevant section. Likewise, the total power assist amount in a certain section is calculated as a sum of the negative charge amount changes for the data collection points where the charge amount has a negative change value based on the above Calc-Step 2. In other words, the total power assist amount is a total value of the decrease of the charge amounts at the data collection points in the relevant section.

Next, in step 140, the SOC loss and gain data calculated in step 130 is recorded to the durable storage media 23 as the learning information. If the vehicle has traveled the same section for multiple times on different occasions (i.e., on different dates), multiple records of the SOC loss and gain (i.e., the power generation/assist amounts) for the same control index and the same section are collected. If the multiple records of the SOC loss and gain have been collected, the average and variance of the power generation/assist amounts for the same control index and the same section may be calculated and recorded separately in the durable storage media 23.

However, due to the change of the actual road environment over time, the reproducibility of the past learning information may decrease. Therefore, after a certain number of SOC loss and gain records are accumulated for the same control index in the same section, the addition of a new SOC data record may be associated with a deletion of the oldest SOC data record for calculating the updated data average and variance. That is, FIFO method may be employed for the update of the SOC data.

Further, in the course of data accumulation and recordation, the power generation/assist amounts for the same control index and the same section may be categorized into days of the week and time slots based on the travel day/time or the start day/time, for the average/variance calculation, if there are multiple records in one category. That is, the SOC data may be recorded and learned as a group of travel days/times or start days/times.

Further, beside the SOC loss and gain for the different control indexes in each of the travel sections, the section average of other factors such as the vehicle speed, road inclination, and travel energy (i.e., required driving energy) of the hybrid vehicle detected by the control unit 24 may be recorded to the durable storage media 23 in association with such categories of traveled sections, days of the week, and time slots of the day.

The learn control process 100 repeatedly performed in the above described manner enables storage of the learning information in the durable storage media 23 for many different sections of the road.

The detail of the SOC planning process 200 is now described. The control unit 24 executes the SOC planning process 200 after the navigation route is calculated by the route calculation process 30 and before the travel of the hybrid vehicle is started. The SOC planning process 200 is a process to formulate an SOC plan for the navigation route by using the learning information regarding the SOC loss and gain which have been recorded in the learn control process 100. The flowchart of the SOC planning process 200 is shown in FIG. 5.

In the SOC planning process 200, the control unit 24 executes the process of steps 210, 220 (or 230) for every section of the navigation route. In step 210, whether or not the learning information regarding the SOC loss and gain for the section currently considered as the determination object (hereinafter, designated as an “object section”) is recorded to the durable storage media 23 is determined. In addition, whether there is the learning information regarding the SOC loss and gain associated with the same day/time category as the current day of the week and the time slot of the day is also determined, if the day/time categorization is used to recorded the SOC data. When the SOC learning information for the object section exists in the storage media 23, the process proceeds to step 220. When the learning information for the object section does not exist in the media 23, the process proceeds to step 230.

In step 220, the SOC losses and gains (the power generation amount and the power assist amount) corresponding to each of the multiple control indexes are calculated by retrieving the learning information of the object section (or by retrieving the learning information of the object section for the specific day/time). If multiple SOC losses and gains are already recorded for each of the control indexes of the object section in the durable storage media 23, the averaged values of the losses and gains are used as the representative SOC loss/gain values corresponding to the relevant control index of the object section.

Further, in step 230 which is executed following a determination that the learning information of the object section is not recorded (or a determination that the learning information of the object section for the specific day/time is not recorded), the road type, average inclination, and average vehicle speed of the object section are acquired for identifying the SOC loss and gain for each of the multiple control indexes. The identification of the SOC loss and gain is performed in a simplified manner, that is, in a method, that does not use the learning information.

The information on the road type and the average inclination of the object section is acquired from the map DB storage 14. More practically, the road type and the average inclination of a link that includes the object section are used as the road type and the average inclination of the object section.

Further, the average speed of the object section is derived from the information from probe cars that have traveled the object section in the past. More practically, the probe information collected, by using the wireless communication device 16, and averaged by a traffic information center is retrieved from the traffic information center by sending a request for the speed information of the object section. If the information on the average speed is not available from the traffic information center, traffic information (such as VICS traffic information implemented throughout Japan) including a current traffic condition may be acquired by using the wireless communication device 16 and the current traffic condition of the object section may be used as the average speed, based on a translation of, for example, traffic smoothness information included therein having multiple speed levels of high, smooth, normal, congested, and no information.

The control unit 24 uses a simplified SOC map to calculate SOC loss and gain for every control index of the object section based on the road type, average inclination and average speed of the object section. The simplified SOC map is prepared in advance for every type of the target vehicle and stored in the ROM 22 before shipping of the navigation ECU 20. The simplified SOC map may alternatively be received from an information center by using the wireless communication device 16.

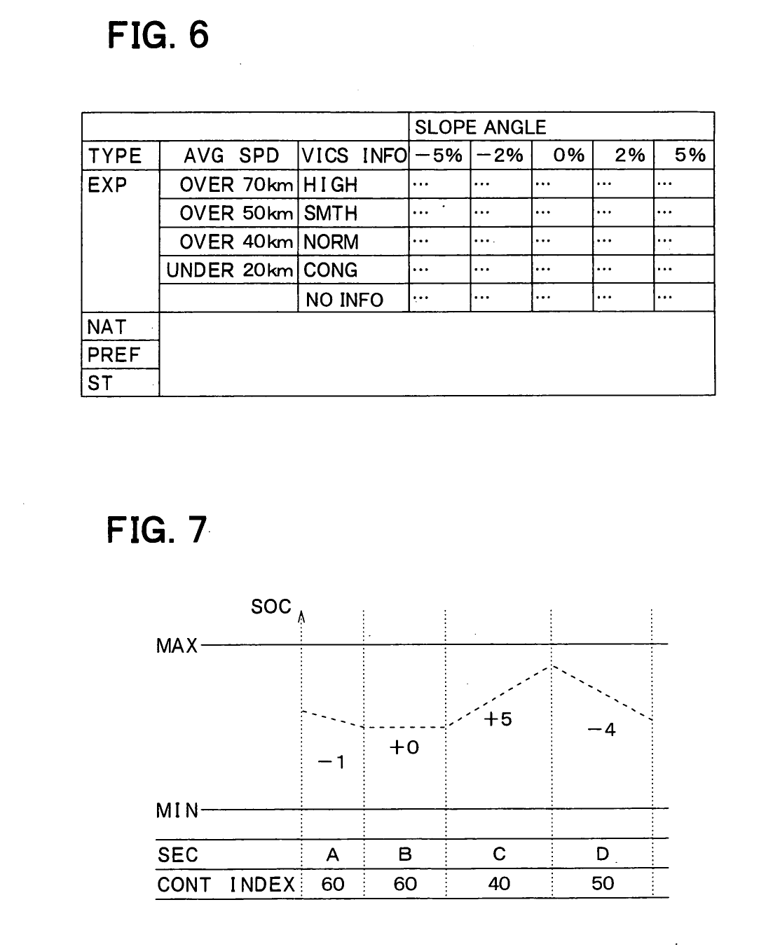

The ROM 22 stores multiple pieces of the simplified SOC map. One SOC map corresponds to one control index. FIG. 6 shows an example of the simplified SOC map corresponding to one control index. As shown in the table in FIG. 6, the simplified SOC map combines the road type, average speed (i.e., smoothness of travel), and average inclination (i.e., a slope angle) to enable the calculation of SOC loss and gain for a unit distance. That is, the power generation amount for a unit distance and the power assist amount for a unit distance are calculated by using the table in the simplified SOC map.

Therefore, as a product of the above value from the SOC map and the section distance, the SOC loss and gain (the power generation amount and the power assist amount) of the object section for each of the control index values are calculated.

As a result, the SOC loss and gain for the entire navigation route are acquired by repeating the above steps of 210 to 230 for each of the sections in the navigation route, based on the available learning information for some sections and the simplified SOC map for other sections. The data format of the SOC loss and gain data is same for both of the “learned section” and the “simplified section.”

In addition, the SOC loss and gain may be corrected by the control unit 24, based on the battery temperature of the battery 9 and the outside temperature, because the electric characteristics of the battery 9 may substantially change depending on the temperature. For example, the calculated value of SOC loss and gain may be corrected to have a smaller value if, for example, the temperature of the battery 9 or the outside temperature is lower than a threshold value of the temperature.

Next, in step 240, an SOC plan for the navigation route is formulated based on the current SOC, a target SOC at the destination, and the acquired SOC losses and gains for each of the sections in the navigation route and for each of the control indexes.

The SOC plan is, more practically, a plan for determining which one of the control indexes is used for each of the sections in the navigation route, together with an estimation of the SOC transition (i.e., an “SOC estimation”) based on the control indexes used in that plan. An example of the SOC plan is shown in FIG. 7. In FIG. 7, the values on the bottom row are a plan of the control index, and the dotted line in the graph shows the SOC estimation.

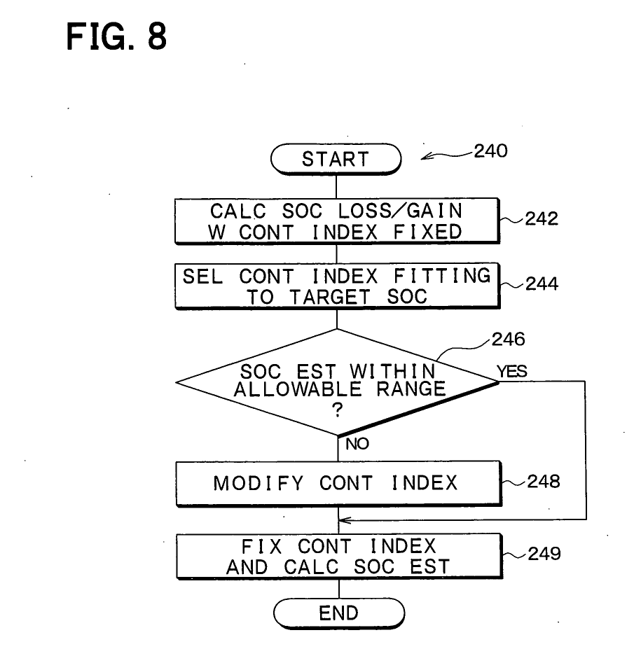

FIG. 8 shows a flowchart of the SOC plan formulation process. In step 242 of the process, each of the control index values in the data acquired in step 220 or 230 is used to calculate a total SOC for the entire navigation route, by calculating a sum of the SOC losses and gains for all of the sections in the route. In this manner, total SOC losses and gains for a travel of the entire navigation route to the destination, with the control index value fixed to each of the available values throughout the travel of the entire route, are calculated.

Next, in step 244, the process adds the current SOC actually observed to each of the variations of the series of the calculated SOC loss and gain transition. The actually observed current SOC is acquired from the HV controller 10. In this manner, for each of the control index values, the SOC at the destination can be calculated. Then, a control index value that yields the SOC value closest to the target SOC is identified and selected from among multiple index values. Then, a plan for traveling the entire navigation route by using the identified control index is tentatively determined.

The target SOC value may be a median of an allowable estimation value range of the SOC, or may be the same value as the current SOC, or may be the minimum value of the allowable estimation value range, as long as the allowable estimation value range falls within a control range of the SOC value.

The control range of the SOC value is a predetermined range of electricity charge amount for preventing an excessive charging and discharging of the battery 9. For example, the maximum value of the control range may be set at the battery charge residue amount of 80%, and the minimum value of the control range may be set at the battery charge residue amount of 40%.

The allowable estimation value range of the SOC is a range within the above control range, with a narrowing margin from the maximum and minimum values of the control range. That is, for example, the upper limit of the allowable estimation value range may be set at a smaller value point by several percents (e.g., 5%) from the maximum value of the control range, and the lower limit of the allowable estimation value range may be set at a greater value point by several percents (e.g., 5%) from the minimum value of the control range.

In step 246, the following three sub-steps are performed. That is, (i) the SOC loss and gain for each of the sections according to the tentative control index plan are calculated based on the SOC loss and gain data regarding the identified control index value from among the index values acquired in steps 220 or 230, and, (ii) the calculated SOC loss and gain are, section by section along the navigation route, added to the current SOC for estimating the SOC transition for the entire navigation route, and (iii) whether the estimated SOC transition is within the allowable estimation value range is determined. If the estimated SOC transition is within the allowable value range, the process proceeds to step 249.

If the estimated SOC transition is not within the allowable estimation value range, that is, if any part of the estimated SOC transition exceeds the allowable value range, the process proceeds to step 248 to fine-tune (i.e., modify) the tentative control index plan, for the purpose of tailoring the SOC transition to be within the allowable value range for the entire navigation route. Then, the process proceeds to step 249.

In step 249, the process adopts, as a final control index plan, either of the fine-tuned plan or the tentative plan in step 244, depending on the preceding steps of the process. Then, according to the final plan, the SOC loss and gain for each of the sections are calculated based on the SOC data acquired in step 220 or 230, and the calculated SOC for each section is added to the current SOC, section by section, for estimating the SOC transition along the navigation route. The estimated SOC transition for the entire navigation route is the “SOC estimation.”

The details of the fine-tuning of the tentative control index plan in step 248 are described in the following. In step 248, the control unit 24 executes following two sub-processes (i) and (ii) in turn for a section that has the greatest amount of excess from the allowable estimation value range.

(i) For a portion of the navigation route prior to the section (i.e., a “prior portion” hereinafter) having the greatest SOC excess value from the allowable estimation value range, uniform changes of the control index value are applied, as trials, for the prior portion, until the SOC estimation for the prior portion falls within the allowable value range. However, if trials of the uniform change of the control index value for the prior portion are not successful in terms of tailoring the SOC estimation to fit in the allowable value range, the control index value is changed to a value that minimizes the number of SOC excess sections that have the SOC value exceeding from the allowable value range.

(ii) For the rest of the navigation route, that is, for a portion from the end of the prior portion to the destination, the same process in steps 242 and 244 is performed. In this case, in step 244, the estimated SOC value at the end of the prior portion in the sub-process (i) is used as the SOC of the start point for the rest of the navigation route, instead of using the current SOC of that section.

Then, until the SOC estimation for all sections in the navigation route fits within the allowable value range, the above sub-processes (i) and (ii) are repeatedly performed for a selected section that has the greatest excess from the allowable value range at each of the repetition cycles.

According to the above processing scheme, a control index that efficiently charges and discharges without excess and shortage of the electric power along the navigation route toward the destination is set, based on the calculation of the SOC loss and gain for each of the control indexes.

If there are regulated areas for a portion of the navigation route that enforces an eco-driving or prohibition of an engine travel for the purpose of preventing emission of the exhaust gas, and the regulation information of those areas is available for the control unit 24 through radio communication by using the wireless communication unit 16, or from the map DB storage 14, the control unit 24 may determine that the SOC plan for that regulated section does not use the engine 1, and may calculate the SOC estimation for that regulated section as the amount of the SOC loss and gain by the EV travel.

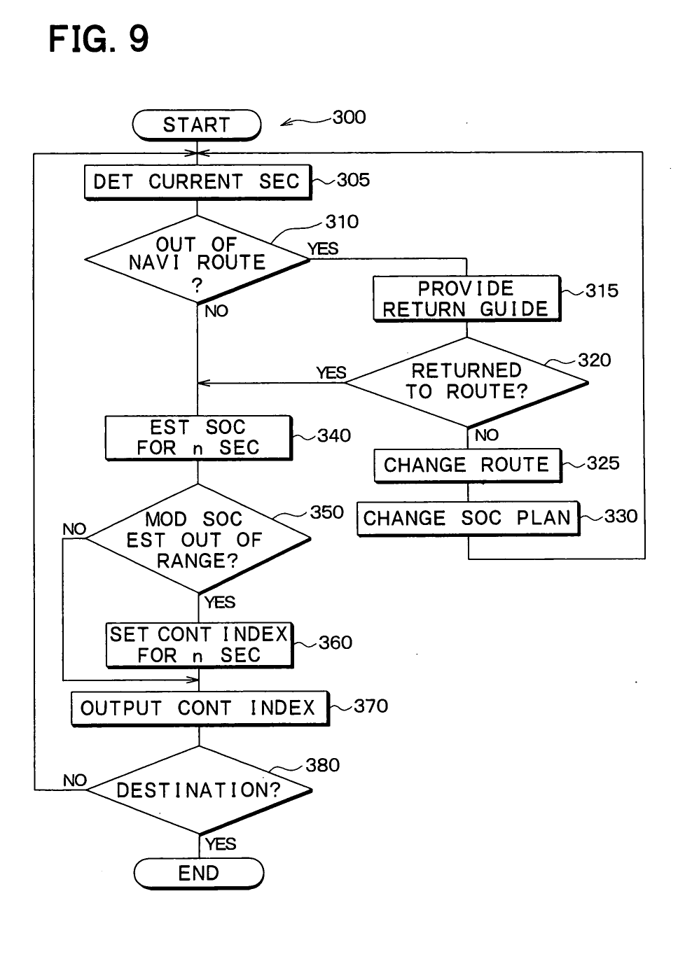

The detail of the travel time process 300 is now described in the following. The control unit 24 starts the execution of the travel time process 300 when the SOC planning process 200 ends and the hybrid vehicle starts the travel on the navigation route. The travel time process 300 is a process that notifies, in each of the sections of the navigation route, the HV controller 10 of the control index to be used in that section, and modifies the SOC plan as required. FIG. 9 shows a flowchart of the travel time process 300.

In the travel time process 300, the control unit 24 identifies and determines, in step S305, a currently-traveled section that is currently traveled by the hybrid vehicle by using the map matching process 29. In step 310, the control unit 24 determines whether or not the hybrid vehicle is traveling away from the navigation route based on the above identification result. If the vehicle is traveling away from the route, the process proceeds to step 315. If the vehicle is not out of the navigation route, the process proceeds to step 340.

In step 315, a return guidance for returning to the navigation route is provided. More practically, a “traveling away from the navigation route” message is provided for the driver of the vehicle by using a display unit or a speaker (not shown in the drawing), together with a proposal of how to return to the navigation route. By providing the return proposal, the driver is encouraged to return to the navigation route. As a result, the SOC plan change caused by the deviation from the navigation route is prevented. Further, the increase of the process load due to the SOC plan change and the fuel mileage deterioration due to frequent re-planning are also prevented.

In step 320, whether the vehicle has returned to the navigation route is examined for a predetermined time of, for example, 10 minutes from the start of step 315, and the process proceeds to step 340 if the vehicle is determined to have returned to the route. If the vehicle has not returned to the route after the predetermined time, the process proceeds to step 325.

In step 325, the route calculation process 30 for calculating the navigation route from the current vehicle position to the destination is performed. By performing the route calculation process 30 again, the navigation route is changed to a new one. Then, in step 330, the SOC planning process 200 is performed again, and the SOC plan is also changed.

In step 340, the SOC transition is newly estimated for a portion of the navigation route from the current section to the n th forward section. The portion of the navigation route is designated as a determination object portion in the following. The number ‘n’ is a natural number, and the number ‘n’ may be arbitrarily determined. That is, for example, the number ‘n’ may be set to define the entire navigation route or half of the navigation route as the determination object portion, or the number ‘n’ may be set as a smaller number for the reduction of the process load of the SOC calculation:

The estimation of the SOC transition is performed by utilizing the SOC estimation in the formulated SOC plan, the current SOC (i.e., the actual SOC observed at the moment), and the information on the current position of the hybrid vehicle.

More practically, based on the SOC estimation, a SOC value at the current position (i.e., a current position SOC estimation) is retrieved, and the current position SOC estimation is subtracted from the current SOC, and the subtraction result is added to the SOC estimation for the subsequent sections that follow the current section. In this case, only the sections in the determination object portion of the navigation route are considered as the subsequent sections. The above process is performed for the adjustment of the difference between the current position SOC estimation and the current SOC. That is, in other words, the SOC difference at the current position is calculated for the adjustment of the SOC estimation in the subsequent sections, so that the SOC estimation in the subsequent sections reflects the current and latest SOC actually observed at the current position. In this case, only the subsequent sections in the determination object portion are considered for the SOC estimation.

In step 350, the after-adjustment SOC estimation (modified SOC estimation in step 350 of FIG. 9) for the determination object portion is examined if there is any portion that exceeds the control range between the SOC maximum value and the SOC minimum value. If there is a portion that has the SOC value exceeding the minimum/maximum of the control range, the process proceeds to step 360. If there is no SOC exceeding section, the process proceeds to step 370. In this case, the SOC exceeding the control range indicates that the battery 9 is overly charged or discharged.

In step 360, the SOC planning process 200 is performed once again, thereby updating (i.e., changing) the SOC plan for the determination object portion of the navigation route. The process then proceeds to step 370. In this manner, a new plan of the control index is determined, thereby enabling a determination of a new SOC estimation. That is, a new SOC plan is formulated, and the new plan fits in the control range.

In step 370, the control index for the current section is extracted from the SOC plan, and the extracted control index is sent to the HV controller 10. In this manner, the HV controller 10 controls the generator motor 2, the power motor 3, the inverter 6, the inverter 8 and the like for satisfying the driver's request of required driving force and for decreasing the fuel consumption, based on the control index received from the navigation ECU 20.

In addition, if the EV travel for the current section has been determined by the SOC planning process 200, the control unit 24 outputs an instruction of the EV travel to the HV controller 10. Upon receiving the EV travel instruction, the HV controller 10 stops the engine 1, and drives the vehicle only by using the power motor 3.

In step 380, it is determined whether or not the hybrid vehicle has arrived at the destination. If the vehicle has arrived at the destination, the process concludes the travel time process 300. If the vehicle has not arrived at the destination, the process returns to step 305 to execute the process again. In addition, step 305 in the execution cycle of steps 305→310→340→350→370→380→305 may be performed at regular intervals, or may be performed only at a timing when the current vehicle position transits from one section to another.

By the execution of the travel time process 300, the control unit 24 repeatedly adjusts the SOC estimation to the actual SOC by the amount of difference between the estimation and actual measurement of SOC at the current position, for the predetermined number of the subsequent sections of the navigation route (refer to steps 340), while the hybrid vehicle is traveling along the navigation route (refer to steps 305, 310, and 380). If the after-adjustment SOC estimation exceeds the control range (refer to steps 350), a new SOC plan is formulated to control the SOC to fit in the control range (refer to steps 370).

The present disclosure of the charge planning apparatus is summarized as follows. The charge planning apparatus used in the hybrid vehicle has the HV controller 10 and the navigation ECU 20, and calculates the vehicle information such as speed, electricity consumption, engine rotation and the like as well as geographical information such as slope of the road and the like, based on signals from various sensors 11, 12, 13, 15 and the like. The charge planning apparatus is equipped with a storage function that stores, in the durable storage media 23, the leaning information that associates every road section with the vehicle information and geographical information, and a planning function that predicts a route to the destination and formulates a SOC plan based on the learning information, and a travel control function that controls the travel of the hybrid vehicle for reducing the fuel consumption.

The advantage of the charge planning apparatus of the present disclosure is that, by estimating the SOC transition in the forward road sections of the navigation route during the travel of the hybrid vehicle and by foreseeing the over-charge/over-discharge that exceeds the SOC control range, the apparatus changes a plan of the control index for controlling the electricity charge/discharge amount, for preventing the loss of “could be stored” electric power and the shortage of electric power.

In other words, the charge planning apparatus compares (a) the current SOC in the SOC transition according to the original plan of control index output to the HV controller 10 (i.e., the transition of the charge amount, or the SOC estimation) and (b) the actually observed current SOC of the battery 9, and modifies the entire SOC estimation by adding a constant value in order to minimize the difference, as a trial. If there still is an excessively charging portion or an excessively discharging portion in the estimated SOC transition for the sections of the forward route after the trial modification of the estimate SOC transition, the original plan of the control index is changed. That is, the re-planning of the original control index plan is triggered when “there is an excessive charging/discharging portion in the modified SOC transition that is modified based on the current (latest) SOC at the moment.”

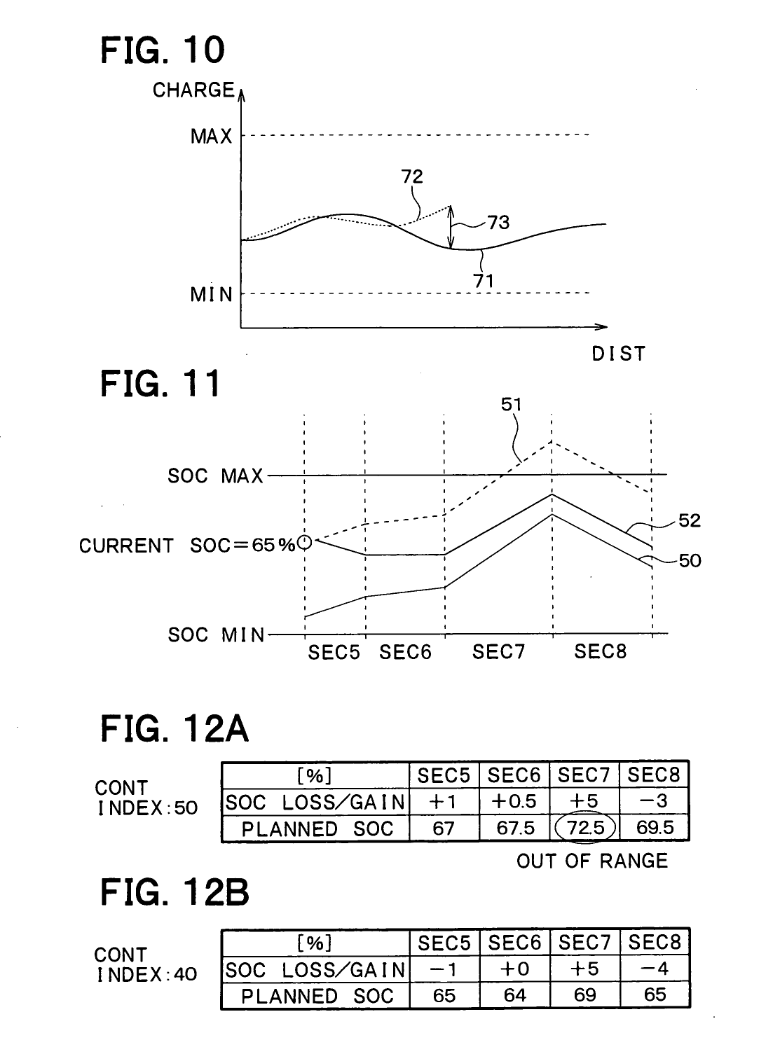

In this manner, the re-planning of the control index becomes less frequent, and the improvement of the fuel mileage is expected. FIG. 10 is used to explain this advantageous feature of the present disclosure. In FIG. 10, the horizontal axis of the graph is the travel distance along the navigation route, and the vertical axis is the charge amount, i.e., the SOC. The area in the graph above the MAX of the charge amount indicates the over-charging, and the area below the MIN of the charge amount indicates the over-discharge. When the charge amount is in an over-charge/discharge condition, the fuel mileage improvement effects are diminished.

In the conventional operation scheme, regardless of whatever the estimation of the SOC transition according to the original plan (along a solid line 71) is, the re-planning is performed whenever the actual SOC (along a dotted line 72) departs from the SOC estimation 71 by a departure amount 73 that exceeds a certain threshold. Therefore, even when the hybrid vehicle is traveling on a level road that does not require a large amount of charge and discharge, with a sufficient margin from the MAX/MIN of the charge amount in the above graph, the re-planning is uniformly performed upon detecting the departure amount 73 exceeding the threshold. That is, the re-planning is unnecessarily performed when it is not required. Repetition of the unnecessary re-planning that does not provide a prospect of the fuel mileage improvement is, in other words, the frequent useless re-planning.

On the other hand, the charge planning apparatus of the present disclosure performs the re-planning only when “there are excessive charging/discharging portions in the modified SOC transition that is modified based on the current (latest) SOC at the moment.” In other words, the re-planning is selectively performed only when the fuel mileage improvement effects are diminished. Therefore, the number of useless re-planning is reduced, thereby enabling the reduction of the process load for the re-planning. Further, by utilizing the vehicle information, slope information in the past travel and the like, the SOC loss and gain can be calculated in advance and stored in the durable storage media for the various control index values for each of the sections of the navigation route, according to the present disclosure.

In other words, the charge planning apparatus of the present disclosure is characterized by the estimation of the SOC loss and gain (i.e., the SOC change amount) for each of the control index values, for “simulating” the travel of the hybrid vehicle in each of the divided sections of the navigation route by assuming that each of the control index values is output to the HV controller 10 during the travel of the present section, and is also characterized by the storage of the estimation of the SOC loss and gain in the durable storage media 23 before formulating the SOC plan for the navigation route, in addition to the formulation of the modified control index plan based on the stored SOC estimation for each of the control index values and for each of the sections in the route.

The storage of the SOC loss and gain for each of the sections and for each of the control index values before the formulation of the plan for a certain route can reduce the re-planning process load, because the stored record/information dispenses the necessity of charge/discharge calculation based on the vehicle speed, slope of the road and the like, which has conventionally been required each time the re-planning process is performed.

Further, the charge planning apparatus may be configured to formulate and modify the plan that enables the SOC transition on the navigation route to fit in the allowable estimation value range that is bound by an upper limit and a lower limit respectively smaller and greater than the minimum/maximum values of the control range, when the control index is output to the HV controller 10 according to the original plan.

When such operation scheme is adopted, the charge amount after plan formulation/modification is controlled to transit within the control range with a margin from the maximum and minimum control range values. Therefore, the possibility of SOC transition exceeding the control range is decreased, even when the travel conditions are changed afterwards. That leads to the advantage of the further reduction of re-planning.

The operation of the travel time process 300 is described with reference to FIGS. 11, 12A, and 12B. The graph in FIG. 11 has a vertical axis showing the SOC value and the horizontal axis showing the sections in the navigation route. Further, tables in FIGS. 12A and 12B are used to display the relation between the control index, the SOC loss and gain, and the SOC estimation in each of the sections.

In this example, the SOC control range is defined as a range between the minimum of 40% and the maximum of 70%, and the control index value of 50 is originally planned to be used in sections 5 to 8. Further, the hybrid vehicle is currently traveling at the start point of section 5, and the current SOC actually observed is 65%, and a graph of the originally estimated SOC transition is drawn in FIG. 11 by using a solid line 50 according to the table in FIG. 12A (i.e., according to the SOC loss and gain row in FIG. 12A).

At this point, the control unit 24 modifies the estimated SOC 50 in step 340 of the travel time process 300 based on the current SOC of 65% at the current vehicle position, and calculates the modified estimation of the SOC transition along a dotted line 51. The post-modification of the SOC estimation along the line 51 can also be calculated by adding the current SOC to the pre-modification SOC loss and gain in the forward sections (refer to FIG. 12A).

That is, the solid line 50 representing the pre-modification transition is uniformly raised to the dotted line 51 representing the post-modification transition of the SOC estimation, according to the current SOC of 65% at the start point of the section 5.

Then, the control unit 24 determines that the above post-modification SOC transition 51 exceeds the maximum value of the control range in section 7, as shown in FIG. 11. That is, if the control index is kept to the value of 50, the post-modification transition of the SOC estimation exceeds the control range due to a large re-generation amount of electricity by the hill descent in section 7. Therefore, in step 360, the control unit 24 formulates a new SOC plan which uses the control index value of 40 in sections 5 to 8. By decreasing the control index value, the ratio of motor output power to engine output power is increased relative to the original SOC plan. Alternatively, the power motor 3 may be used to drive the hybrid vehicle for a longer period of time, for the purpose of increasing the use of the electricity in the battery 9 in the forward sections. By increasing the use of the battery 9, the estimated SOC 52 according to the new SOC plan is reduced to fit in the control range, as illustrated in FIGS. 11 and 12B. In other words, the charged electricity by the hill descent in section 7 will not be wasted.

Therefore, by always foreseeing and estimating the SOC in the forward sections, loss of the re-generated electricity and electricity shortage in the congested sections are prevented in the above-described manner.

Examples of the control index are described in the following. The control, index is used to control the output of the engine 1, the generator motor 2, and the power motor 3. For example, the control index may be a power threshold that is used to determine which of the electric power generation (i.e., re-generation of electricity, or the internal-combustion charging) or the motor-assisted travel should be conducted, or may be an engine-motor output ratio.

The case in which the power threshold is used as the control index is described first. As described above, the control unit 24 performs the following process in the Calc-Step 2 of step 130 when calculating the SOC loss and gain (i.e., the power generation amount and the power assist amount) for each of the sections for each of the control index values in the learn control process 100.

(Calc-Step 2)

Based on the calculated travel load P and the employed control index, the power generation amount or the power assist amount at the current data collection point is calculated. More practically, the power generation/assist amount between the current data collection point and the next data collection point is calculated.

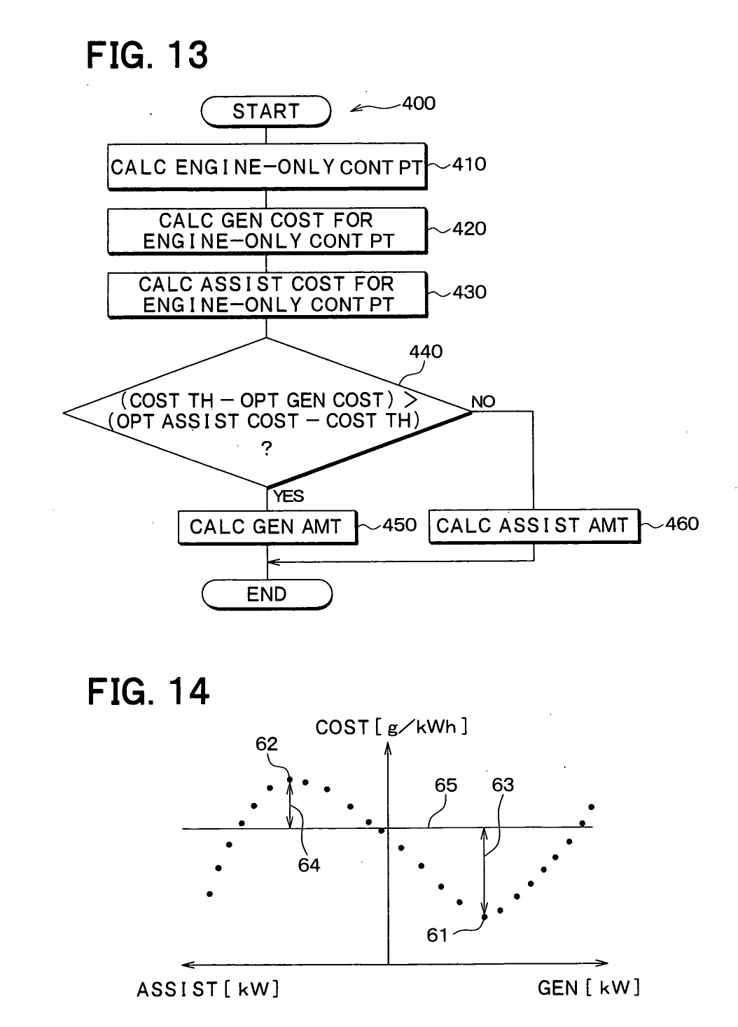

When the power threshold is used as the control index, the details of the Calc-Step 2 are the process illustrated in a flowchart shown in FIG. 13. First, the control unit 24 calculates an “engine operation point” that provides the travel load P of the travel data collection point calculated by the Calc-Step 1 in step 410 by employing the entire power of the engine 1 only, without using the power motor 3. The engine operation point providing the travel load P is designated as the first engine control point. The engine operation point is a point in a two dimensional space defined by two parameters of the torque of the engine 1 (Nm: Newton-meter) and the rotation number (rpm: revolutions per minute). The first engine control point based on the travel load P is calculated by a method that uses a map stored in, for example, in the ROM 22. The map in the ROM 22 defines the relation between an input of the travel load P and an output of the first engine control point.

Further, the fuel consumption per unit time (gram/hour) at the calculated first engine control point is calculated. This calculation is also performed by using a map stored in, for example, the ROM 22. The map in the ROM 22 defines the relation between an input of the engine operation point and an output of the fuel consumption per unit time.

In this case, if there are multiple first engine control point candidates, only one candidate that minimizes the fuel consumption per unit time is used as the first engine control point.

Next, in step 420, the increase of the fuel consumption per unit time in case the generated electricity power (kW) is increased from the amount at the first engine control point is calculated for each of the multiple values of the increase of the generated electricity power. The increase of the fuel consumption and the increase of the generated electricity power in this case mean, respectively, the amount of increase from the fuel consumption at the first engine control point and the amount of increase from the generated electricity power at the first engine control point.

Further, “in case the generated electricity power is increased from the amount at the first engine control point” means the engine operation point is positioned as a point at which both of the travel load P used to calculate the first engine control point and the amount of the increase of the generated electricity power are covered by the entire output of the engine 1 only. This engine operation point is also calculated based on a map that maps the relation between the input of both of the travel load P plus the increase of the generated electricity power and the output of the engine operation point stored in, for example, the ROM 22. In this case, if there are multiple engine operation points, only one point that minimizes the fuel consumption per unit time is employed as the engine operation point.

In step 420, each of the calculated increases of the fuel consumption per unit time is divided by the corresponding increase of the generated electricity power. The result of the division is the value of a power generation cost (g/kWh). The power generation cost means a ratio of the increase of the fuel consumption (i.e., the increase per unit time) consumed by the engine 1 relative to the increase of the generated electricity power when the engine power is increased to increase the amount of generated electricity power. As described above, for each of the multiple increases of the generated electricity power relative to the amount at the first engine control point, the power generation cost is calculated in step 420.

In the two right quadrants of the graph shown in FIG. 14, a series of points are plotted for showing an example of the power generation cost. In the graph in FIG. 14, the horizontal axis shows the increase of the generated electricity power relative to the amount at the first engine control point, and the vertical axis shows the power generation cost (or a power assist cost, to be described later in detail). When the power generation cost is lower, the fuel consumption for generating unit electricity power decreases, which is more preferable. In this case, among the multiple values of the power generation cost, the lowest value is designated as an optimum power generation cost 61. In addition, when the electricity is generated by re-generation, the power generation cost is equal to zero, because the fuel consumption does not increase due to the re-generation.

Next, in step 430, the reduction of the fuel consumption per unit time in case the assist electricity power (kW) is increased from the amount at the first engine control point is calculated for multiple values of increase of the assist electricity power. The assist electricity power means the electric power used to drive the power motor 3 for the purpose of the motor-assisted travel. The reduction of the fuel consumption and the increase of the assist electricity power respectively mean the reduction of the fuel consumption relative to the amount at the first engine control point and the increase of the assist electricity power relative to the amount at the first engine control point.

Further, “in case the assist electricity power is increased from the amount at the first engine control point” means a specific position of the engine operation point at which the travel load P used to calculate the first engine control point is covered by both of the entire output of the power motor 3 due to the increase of the assist electricity power and the entire output of the engine 1. This engine operation point is also calculated based on a map that maps the relation between the input of both of the travel load P plus the increase of the assist electricity power and the output of the engine operation point stored in, for example, the ROM 22. In this case, if there are multiple engine operation points for the same amount of increase of the assist electricity power, only one point that minimizes the fuel consumption per unit time is employed as the engine operation point.

In step 430, each of the calculated reductions of the fuel consumption per unit time is divided by the corresponding increase of the assist electricity power. The result of the division is the value of an assist electricity cost (g/kWh). The assist electricity cost means a ratio of the reduction of the fuel consumption (i.e., the reduction per unit time) consumed by the engine relative to the increase of the assist electricity power when the motor power from the power motor 3 is increased to increase the amount of the assist electricity power. As described above, for each of the multiple reductions of the assist electricity power relative to the amount at the first engine control point, the assist electricity cost is calculated in step 430.

In the two left quadrants of the graph shown in FIG. 14, a series of points are plotted for showing an example of the assist electricity cost. When the assist electricity cost is higher, the reduction amount of the fuel consumption for generating unit electricity power increases, which is more preferable. In this case, among the multiple values of the assist electricity cost, the highest value is designated as an optimum assist electricity cost 62.

In step 440, from a power threshold 65 currently being used (i.e., the currently used control index), the optimum power generation cost 61 is reduced to yield a power improvement amount 63, and from the optimum assist electricity cost 62, the same power threshold 65 is reduced to yield a power improvement amount 64. The two improvement amounts 63 and 64 are compared with each other, and the process proceeds to step 450 if the amount 63 is greater, or otherwise proceeds to step 460. This step determines which of the two benefits, that is, a benefit of electricity generation and a benefit of charging electricity, is greater at the current travel data collection point.

In step 450, following a condition that the power improvement amount 63 in the power generation is determined to be greater than the power improvement amount 64, the power generation amount is calculated. More practically, the power generation amount at the present data collection point is calculated as a product of the optimum power generation cost 61 and a travel time T between the current data collection point and the next data collection point. In this case, time T is calculated by dividing the inter-point distance (between the current and next data collection point) by the vehicle speed V at the present data collection point.

In step 460, following a condition that the power improvement amount 64 in the assisted travel is determined to be greater than the power improvement amount 63, the power assist amount is calculated. More practically, the power assist amount at the current data collection point is calculated as a product of the optimum assist electricity cost 62 and a travel time T between the current data collection point and the next data collection point, with the reversal of sign (i.e., the calculation result takes a negative value). After step 450 or 460, the Calc-Step 2 concludes itself. However, if both of the power improvement amounts 63 and 64 take a negative value in step 440 of the details of the Calc-Step 2, neither of the two amounts, i.e., the power assist amount nor the power generation amount is calculated. In other words, both of the power assist amount and the power generation amount for the present data collection point are determined as zero.

Further, how the HV controller 10 is operated when the HV controller 10 receives an output of the control index from the navigation ECU 20 in step 370 of FIG. 9 is described, in case that the power threshold is used as the control index.

As described above, when the HV controller 10 receives a control index from the navigation ECU 20, the controller 10 controls the generator motor 2, the power motor 3, the inverter 6, the inverter 8 together with other parts, to satisfy the required driving force from the driver and to reduce the fuel consumption, based on the latest control index just received.

More practically, the HV controller 10 determines a requested power SPw requested from the hybrid vehicle. The requested power SPw is determined based on a current accelerator opening amount and a current vehicle speed by employing a map stored in a ROM of the controller 10 or the like. The amount of the accelerator opening is acquired from an accelerator opening sensor (not shown in the drawing), and the vehicle speed may be directly acquired from the speed sensor 13, or may be acquired from the navigation ECU 20.

Then, the HV controller 10 determines whether or not the motor-assisted travel is performed, and whether or not the internal-combustion charging is performed, based on the requested power SPw just determined and the latest control index acquired from the navigation ECU 20. Further, the output electricity power from the motor 3 (i.e., the assist electricity power) is determined in case that the motor-assisted travel is determined to be performed, or the power generation amount by the generator motor 2 is determined in case that the internal-combustion charging is determined to be performed. Then, for realizing the determined operation, the HV controller 10 controls the generator motor 2, the power motor 3, the inverter 6, the inverter 8 and the like in a well-known manner. In the process of these determinations, the requested power SPw is basically used in place of the travel load P in the process of the Calc-Step 2 shown in FIG. 13.

More practically, the HV controller 10 determines the engine operation point of the engine 1, to satisfy the determined amount of the requested power SPw by using the entire output of the engine 1 only. The engine operation point thus determined is designated as the second engine control point hereinafter. The second engine control point is determined by a method that uses a map that maps the relation between the input of the requested power SPw and the output of the second engine control point stored in, for example, the ROM of the HV controller 10. In this case, if there are multiple second engine control point candidates, only one candidate that minimizes the fuel consumption per unit time is used as the second engine control point.

Then, the HV controller 10 calculates the increase of the fuel consumption per unit time in case the generated electricity power (kW) is increased from the amount at the second engine control point is calculated for each of the multiple values of the increase of the generated electricity power. In this case, “in case the generated electricity power is increased from the amount at the second engine control point” means the engine operation point is positioned at a point at which both of the travel load P used to calculate the second engine control point and the amount of the increase of the generated electricity power are covered by the entire output of the engine 1 only. This engine operation point is also calculated based on a map that maps the relation between the input of both of the requested power SPw plus the increase of the generated electricity power and the output of the engine operation point stored in, for example, the ROM of the HV controller 10. In this case, if there are multiple engine operation points for the same amount of increase of the generated electricity power, only one point that minimizes the fuel consumption per unit time is employed as the engine operation point.

Next, the HV controller 10 divides each of the calculated increases of the fuel consumption per unit time by the corresponding increase of the generated electricity power amount. The value of the division result is the power generation cost (g/kWh). In this manner, the HV controller 10 calculates the power generation cost for each of the multiple values of increase of the generated electricity power at the second engine control point.

Then, the HV controller 10 calculates the amount of reduction of the fuel consumption per unit time in case the assist electricity power (kW) is increased from the amount at the second engine control point for multiple values of increase of the assist electricity power. In this case, “in case the assist electricity power is increased from the amount at the second engine control point” means the engine operation point is positioned at a point at which the requested power SPw used to calculate the second engine control point is covered by both of the entire output of the power motor 3 due to the increase of the assist electricity power and the entire output of the engine 1. This position of the engine operation point is also calculated based on a map that maps the relation between the input of both of the requested power SPw plus the increase of the assist electricity power and the output of the engine operation point stored in, for example, the ROM 22. In this case, if there are multiple engine operation points for the same amount of increase of the assist electricity power, only one point that minimizes the fuel consumption per unit time is employed as the engine operation point.

Further, the HV controller 10 divides each of the calculated reductions of the fuel consumption per unit time by the corresponding increase of the assist electricity power. The value of the division result is the assist electricity cost (g/kWh). As described above, for each of the multiple increases of the assist electricity power at the second engine control point, the HV controller 10 calculates the assist electricity cost.

Then, the HV controller 10 compares two amounts of improvement, one calculated by the reduction of the optimum power generation cost from the latest power threshold (i.e., the control index), and the other calculated by the reduction of the latest power threshold from the optimum assist electricity cost. If the former amount of improvement is greater, the power generation is determined, thereby determining that the power generation amount at the optimum power generation cost is the power generation amount to be generated. If the latter amount of improvement is greater, the motor-assisted travel is determined, thereby determining that the assist electricity power at the optimum assist electricity cost is the electricity power to be output from the power motor 3.

In the following, the case in which the engine-motor output ratio is used as the control index is described. The engine-motor output ratio is defined as a ratio of the output power from the motor 3 against the output power of the engine 1, or a ratio of the generated electricity power from the generator motor 2 against the output power of the engine 1. When the electricity is discharged, the ratio takes a positive value, and when the electricity is generated, the ratio takes a negative value. The value of the ratio is equal to zero, when neither of the discharge or the generation is performed.

More practically, when the electricity is discharged, the engine-motor output ratio is the value calculated by dividing the output power of the motor 3 by the output power of the engine 1, and when electricity is generated, the engine-motor output ratio is the value calculated by dividing the generated electricity from the generator motor 2 by the output power of the engine 1, with the reversal of the sign by multiplying a minus 1 (i.e., ±1).

Therefore, as the engine-motor output ratio becomes greater, the motor-assisted travel by using the motor 3 becomes more frequent than the charging of the battery 9 by using the generator motor 2. In other words, the ratio of the output from the motor 3 against the output from the engine 1 becomes greater, and the ratio of the output from the generator motor 2 against the output from the engine 1 becomes smaller.

When the engine-motor output ratio is used as the control index, how to calculate the power generation amount or the power assist amount at a travel data collection point based on the travel load P by using the Calc-Step 2 of step 130 in the learn control process 100 is described in the following.

First, the control unit 24 calculates the generated electricity power or the assist electricity power at the travel data collection point that satisfies both of the expected travel load P and the engine-motor output ratio at that data collection point. In this case, if the engine-motor output ratio is a positive value, the assist electricity power is calculated, and if the ine-motor output ratio is a negative value, the generated electricity power is calculated.

Then, the control unit 24 calculates the power generation amount or the power assist amount by multiplying the calculated assist electricity power or the calculated generated electricity power by the travel time of the hybrid vehicle between the current travel data collection point and the next point.

Further, the operation of the HV controller 10, in case the control index output from the navigation ECU 20 in step 370 of FIG. 9 is received by the HV controller 10, is described in the following. When the HV controller 10 receives the control index from the navigation ECU 20, it controls the generator motor 2, the power motor 3, the inverter 6, the inverter 8 and the like for satisfying the driver's request of required driving force and for satisfying the engine-motor output ratio based on the latest control index just received.

### OTHER EMBODIMENTS

Although the present disclosure has been fully described in connection with preferred embodiment thereof with reference to the accompanying drawings, it is to be noted that various changes and modifications will become apparent to those skilled in the art.

For example, the control unit 24 may execute the learn control process 100 shown in FIG. 3 whenever the hybrid vehicle is traveling, instead of executing the process 100 only when the navigation process 40 starts the route guidance toward the destination. In that case, determination of the arrival to the destination in step 120 may be replaced with the determination of turning off of the ignition switch of the hybrid vehicle.

Further, in the above embodiment, the control unit 24 may limit the object section for recording the learning information regarding the SOC loss and gain only to a frequently traveled section, instead of all of the traveled sections by the hybrid vehicle, in the learn control process 100.

The frequently traveled section may be determined as a section that has been traveled by the hybrid vehicle for more than a certain number (e.g., for more than ten times) in the past of certain duration (e.g., for one month). Alternatively, by determining a frequently guided route between two registered points such as the home of the driver and the office, all of the sections in the frequently guided route between the home and the office may be determined as the frequently traveled sections. The frequently guided route may be defined to start from home to reach the office, or to start from the office to return to home.

According to the research conducted by the inventor, 53% of the drivers have a frequently traveled route of home to home, or home to destination to home. When a certain route is frequently traveled, that route can be the most accurately learned route. Therefore, while a highly accurate learning effect is achieved, the amount of records of the learning information is reduced by limiting the object section of learning only to the frequently traveled route.

Further, the learning information may be uploaded to an information center outside of the hybrid vehicle by radio communication. In this case, the information center may collect the learning information from the multiple hybrid vehicles, and may sort the collected information into categories based on the vehicle types, for the purpose of calculating and recording the averages and variances of SOC loss and gain for respective vehicle types. The hybrid vehicles may, in turn, download the learning information from the information center only by the required amount, on demand. In this manner, the storage volume in the navigation ECU 20 can be reduced, and the learning information of the same vehicle type can be shared with other vehicles.

Further, the control unit 24 may correct the SOC loss and gain of the object section calculated in step 220 of the SOC planning process 200 if, based on the current traffic information of the object section (such as VICS information implemented in Japan), the traffic condition is different from the condition at the time of acquisition of the learning information. For this purpose, the control unit 24 may record the SOC loss and gain and the control index in association with the traffic information and the probe car information at the time of learning of the SOC loss and gain and the control index in the learn control process 100. In this manner, the SOC planning can be configured to reflect the current traffic condition.

Further, in the above embodiment, for each of the control index values and for each of the sections, the SOC loss and gain are recorded in different categories, that is, recorded separately as the power generation amount and the power assist amount. However, the SOC loss and gain may be recorded in a different manner.

For example, the power generation amount may be categorized into the respective purposes of electricity consumption for the purpose of recording. That is, the record categories may include the power generation amount by re-generation, the power consumption by accessories (i.e., supplemental electric devices in the vehicle such as an air-conditioner, audio-visual devices, headlights and the like that are not used to drive the vehicle), the power consumption by the motor-assisted travel other than the EV travel, the power consumption by the EV travel, and the like.

In this manner, the correction of the SOC loss and gain may be performed for each of the respective items of those categories (i.e., for each of the respective purposes of power consumption). Therefore, the SOC loss and gain correction may be more accurately performed. This is because SOC affecting factors are different from item to item.

The case that SOC loss and gain in the learning information are corrected when the traffic information (i.e., VICS information), the probe car information (i.e., the vehicle speed information), the battery temperature and the like are changed, in the course of SOC plan formulation in step 240 of the SOC planning process 200 and in the course of control index setting in step 360 of the travel time process 300 is now considered. In this case, the control unit 24 may use respectively different correction methods for appropriately correcting each of those items.

For example, the SOC decrease in each of the sections due to the power consumption by the accessories may be corrected in proportion to the travel time for that section based on the probe car information. In addition, the SOC decrease in each of the sections due to the power consumption by the EV travel may be corrected in proportion to the section length when the relevant section is expected to be congested according to the traffic information.

Further, a part of the learning information, that is, the power generation amount from the re-generation and the power consumption amount by the accessories, may be recorded as common information for all of the control index values, instead of recording that information separately in association with each of the control index values, because those information is not affected by the control index. In this manner, data volume in the control unit 24 as well as surplus calculation load can be reduced.

Further, the control unit 24 may calculate the SOC transition for each of the possible combinations of the control index values in all sections of the navigation route, and may employ, as a control index plan, the combination of the control index values which achieves (a) the target SOC at the destination of the travel, and (b) the SOC transition that fits in the SOC control range in all sections of the route, when formulating the SOC plan in step 240 of the SOC planning process 200, besides the formulation method described in the above.

Further, in case that, due to an unexpected congestion or the like which is different from the usual condition, the SOC estimation is not usable during execution of the travel time process 300, the control unit 24 may stop the execution of the travel time process 300 based on the data collected in the past travel. That is, based on the detected average speed, average slope angle, and average travel energy during the travel of the navigation route, the travel time process 300 may be stopped if all of those items (or at least one of those items) are different by more than a certain amount from the data collected on the same day of the week and the same time of the day from the past travel. Furthermore, if the traffic information (e.g., VICS information) received by the wireless communication unit 16 is different from the past record of the traffic information in the learn control process 100 by more than a certain “amount” in addition to the average speed, slope, and energy, the travel time process 300 may be stopped, or the SOC estimation may be corrected.

Further, the control unit 24 may stop the formulation of the SOC plan, or may calculate the SOC loss and gain by performing step 230, if, in a certain section of the navigation route, the learning information retrieved in step 220 of the SOC planning process 200 has the variance of the SOC loss and gain greater than a certain threshold. This is because the SOC loss and gain may possibly change by a large amount depending on a condition when the SOC loss and gain variance of the section is large.

Further, though, in the above embodiment, the charge planning apparatus is composed of two units of the HV controller 10 and the navigation ECU 20, the charge planning apparatus may be formed only by one unit that has the function of both of the HV controller 10 and the navigation ECU 20.

Further, each of the functions realized by the execution of a program by the control circuit 24 in the above embodiment may be alternatively realized by using hardware that is capable of enabling those functions such as an FPGA which is programmable to implement a required circuit, for example.

Such changes, modifications, and summarized scheme are to be understood as being within the scope of the present disclosure as defined by appended claims.

What is claimed is:

1. A charge planning apparatus in a hybrid vehicle that is driven by a power of an internal combustion engine and a power of a battery, the apparatus comprising:
a controller for controlling (a) driving of the hybrid vehicle by the battery and (b) charging of the battery based on a received control index;
a plan formulator for formulating a plan of the control index on an expected travel route of the hybrid vehicle and for predicting a charge amount transition of the battery on the expected travel route based on the control index output to the controller;
a modification determiner for determining modification of the plan during a travel of the vehicle on the expected travel route based on (a) the charge amount transition caused by the output of the control index according to the plan and (b) a current battery charge amount;
a plan modifier for modifying the plan based on an affirmative determination of the modification determiner and for predicting the charge amount transition on the expected travel route according to the control index output to the controller corresponding to the modified plan; and
an output generator for outputting the control index to the controller according to the plan, wherein
(i) the modification determiner modifies, based on the current battery charge amount that is actually observed, the charge amount transition according to the control index output to the controller corresponding to the plan, and
(ii) the modification determiner determines to change the plan when the modified charge amount transition has an excessively charging or discharging portion of the battery charge amount.

2. A charge planning apparatus in a hybrid vehicle that is driven by a power of an internal combustion engine and a power of a battery, the apparatus comprising:
a controller for controlling (a) driving of the hybrid vehicle by the battery and (b) charging of the battery based on a received control index;
a plan formulator for formulating a plan of the control index on an expected travel route of the hybrid vehicle and for predicting a charge amount transition of the battery on, the expected travel route based on the control index output to the controller;
a modification determiner for determining modification of the plan during a travel of the vehicle on the expected travel route based on (a) the charge amount transition caused by the output of the control index according to the plan and (b) a current battery charge amount;
a plan modifier for modifying the plan based on an affirmative determination of the modification determiner and for predicting the charge amount transition on the expected travel route according to the control index output to the controller corresponding to the modified plan;
an output generator for outputting the control index to the controller according to the plan; and
a recorder for recording, in a memory medium prior to formulation of the plan for the expected travel route by the plan formulator, variation of the battery charge amount according to the control index output to the controller, when the expected route is divided into multiple sections and the variation of the battery charge amount is predicted for multiple component values of the control index for respective sections of the expected travel route, wherein
the plan modifier formulates a control index use plan that defines use of the multiple components of the control index in each of the multiple sections of the expected travel route in the modified plan, by utilizing the recorded variation of the battery charge amount for respective sections of the expected travel route and respective components of the control index.

3. The charge planning apparatus of claim 2,
the modification determiner modifies, based on the current battery charge amount that is actually observed, the charge amount transition according to the control index output to the controller corresponding to the plan, and
the modification determiner determines to change the plan when the modified charge amount transition has an excessively charging or discharging portion of the battery charge amount.

4. The charge planning apparatus of claim 1, wherein
the plan formulator and the plan modifier formulates or modifies the plan so that the charge amount transition on the expected travel route according to the control index output to the controller corresponding to the formulated/modified plan has a value between an upper and lower limit of a battery charge control range that defines an excessive charge and discharge.

5. The charge planning apparatus of claim 3, wherein
the plan formulator and the plan modifier formulates or modifies the plan so that the charge amount transition on the expected travel route according to the control index output to the controller corresponding to the formulated/modified plan has a value between an upper and lower limit of a battery charge control range that defines an excessive charge and discharge.
